(19) United States
(12) Patent Application Publication
(10) Pub. No.: US 2026/0105494 A1
(43) Pub. Date: Apr. 16, 2026

(54) END-TO-END ARTIFICIAL INTELLIGENCE MARKETING PROCESS, SYSTEM AND ARCHITECTURE

(71) Applicant: OWL. I CORP., Fort Lauderdale, FL (US)

(72) Inventors: Joshua J. BRUNSON, Fort Lauderdale, FL (US); Megan Michelle COBB, Fort Lauderdale, FL (US); Elisa Alexandra Hamdan HENRY, Fort Lauderdale, FL (US); Alexis Kay SENTINELLA, Fort Lauderdale, FL (US)

(21) Appl. No.: 19/224,704

(22) Filed: May 30, 2025

Related U.S. Application Data
(60) Provisional application No. 63/706,056, filed on Oct. 11, 2024.

(51) Int. Cl. G06Q 30/0241; G06Q 30/0251

(52) U.S. Cl. CPC G06Q 30/0276; G06Q 30/0269

(57) ABSTRACT

An end-to-end marketing system and process that leverages Artificial Intelligence to produce customized content deliverable via, for example, social media and email service provider platforms.

### CROSS-REFERENCE TO RELATED APPLICATIONS

This application is based on, and claims priority to, U.S. Provisional Application No. 63/706,056, filed on Oct. 11, 2024, the entire contents of which being fully incorporated herein by reference.

### BACKGROUND OF THE INVENTION

The present invention relates to marketing systems, and more particularly, to an end-to-end marketing system and process that leverages Artificial Intelligence to produce customized content deliverable via, for example, social media and email service provider platforms.

The typical marketing lifecycle begins with brand-building through advertising and content creation to make a business, service, or product standout, and extends to the creation of long term, loyal supporters. Executing a cohesive marketing campaign typically requires the effective utilization of a seasoned expert in the marketing lifecycle stages of awareness, consideration, conversion, activation, loyalty, and advocacy. However, with the proliferation of the Internet and online content creation more and more individuals are seeking to insource marketing campaigns.

Current tools for online marketing are diverse and disjointed, typically only covering a portion of the marketing lifecycle, and requiring a user to learn multiple different systems to create a cohesive marketing campaign. Furthermore, these tools lack the intuitive approach needed to shepherd a marketing novice through the entire lifecycle without encountering a steep learning curve. Finally, these tools are typically algorithmic in nature, requiring a user to follow a fixed set of steps, which removes the human element needed to support a robust marketing campaign.

As can be seen, there is a need for an end-to-end marketing system that organically supports a user through a marketing campaign's lifecycle.

### BRIEF DESCRIPTION OF THE DRAWINGS

FIG. 1A-1E is a wireframe system diagram of an embodiment of a marketing content creation platform, according to aspects of the present invention.

FIGS. 2-16 illustrate an example “walk-through” of the operation and use of the method and processes of the present invention, using an exemplary dashboard displayed in a graphic user interface.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Current personal marketing tools are disjointed, typically require a steep learning curve, and fail to inject a human element into the marketing process. Broadly, an embodiment of the present invention provides an AI-guided end-to-end interactive marketing experience that reintroduces the human element and streamlines the creation and scheduling of marketing content, producing content tailored to, and ready for delivery via, one or more social media and/or email service provider platforms.

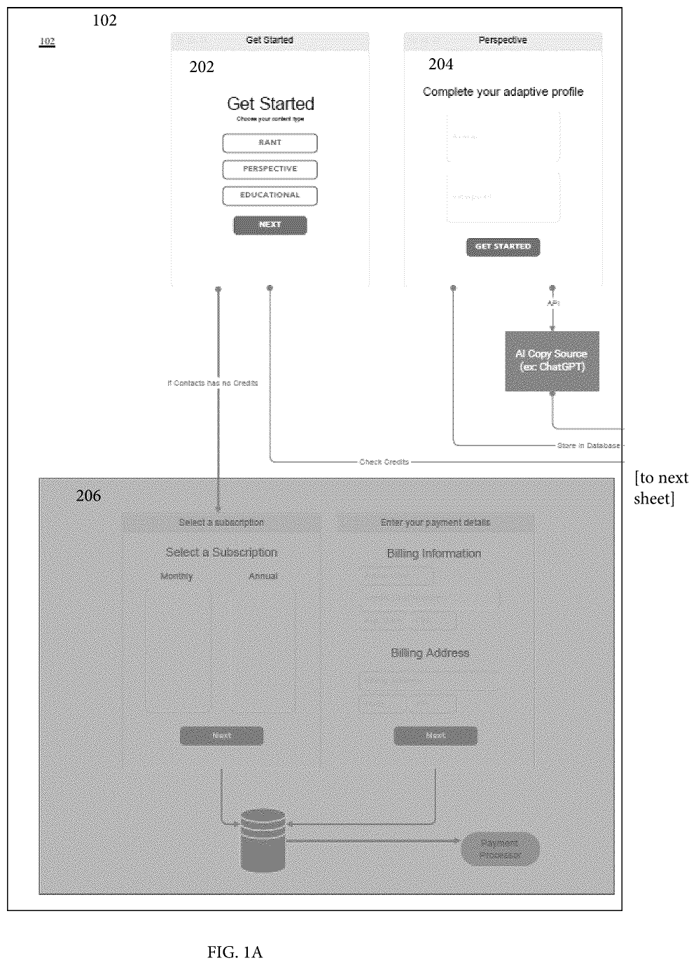

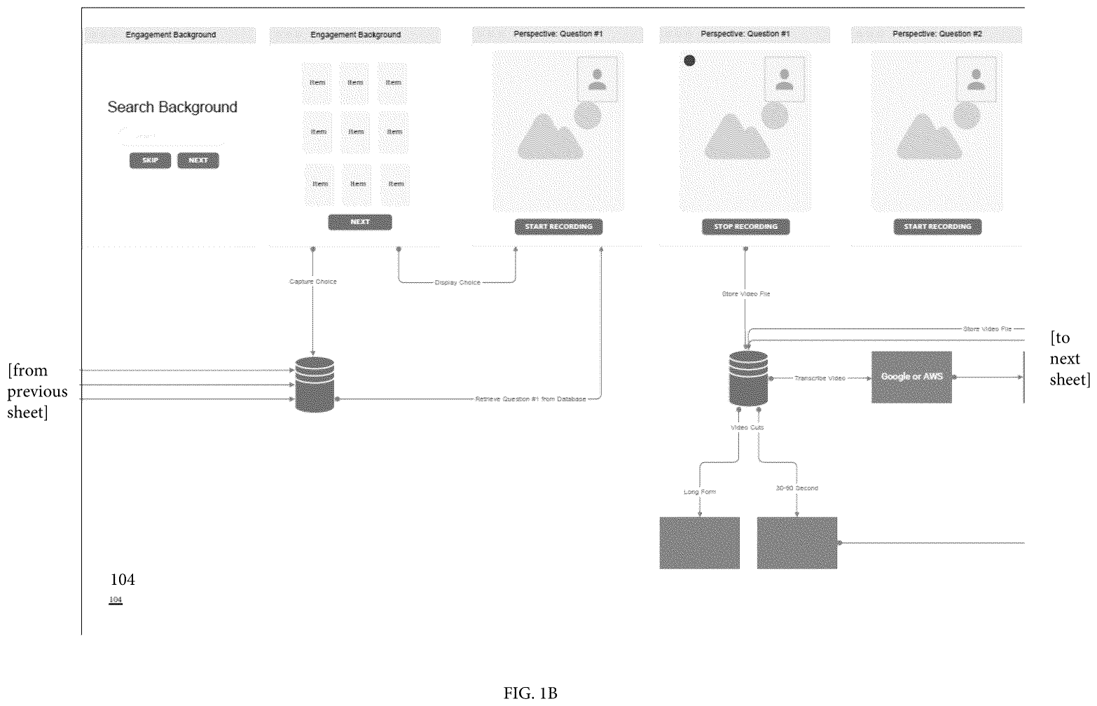

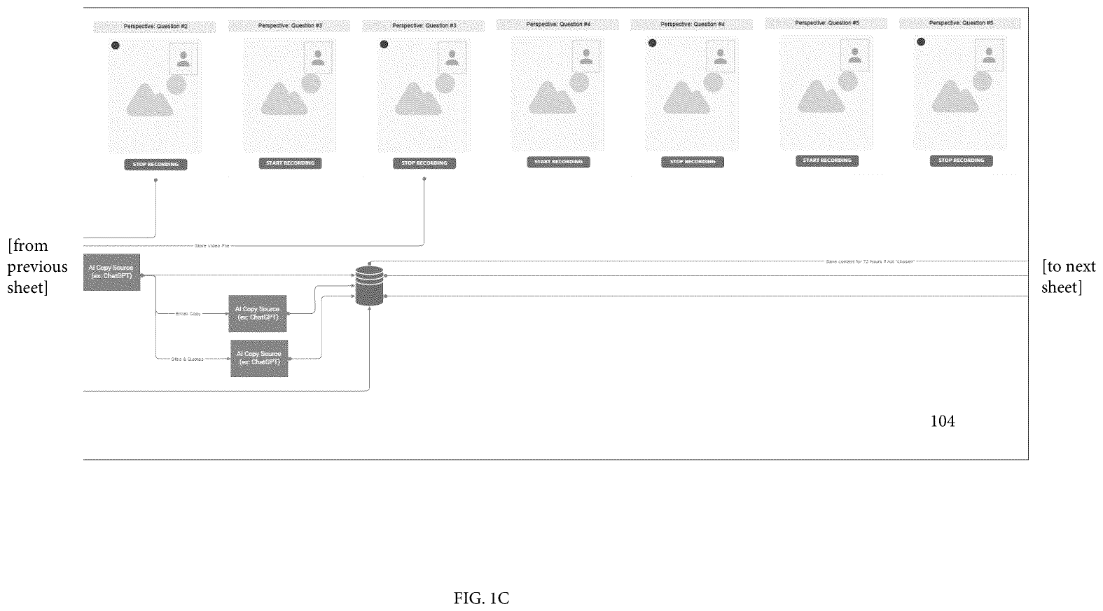

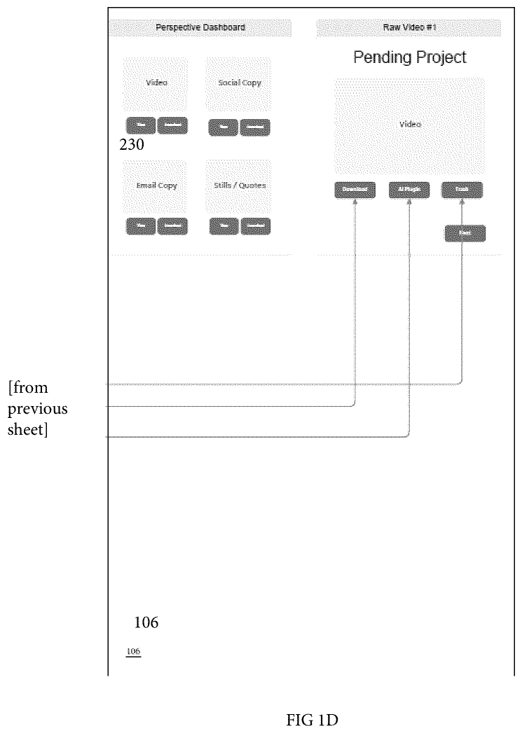

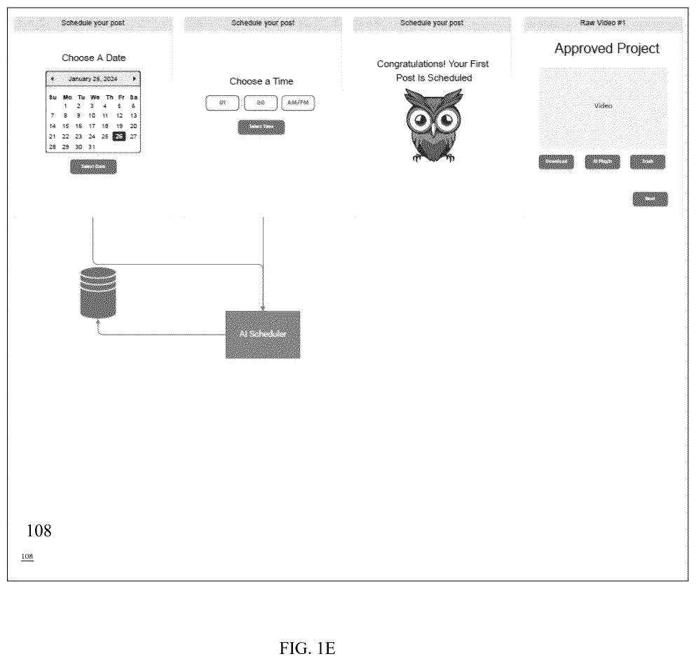

Referring now to FIGS. 1A-1E, an end-to-end marketing system 100 is illustrated, according to aspects of the present invention. System 100 can include a start-up module 102, a guided content creation module 104, a content finalization module 106, and a content scheduling module 108. It is understood that, while specific modules are shown, additional modules can be contemplated without departing from the scope of the invention.

A user accesses start-up module 102, which can provide a “get started” mechanism 202, a profile mechanism 204, and an access control mechanism 206. As an initial matter the access control mechanism 206 can determine if the user has sufficient credits, paid or otherwise obtained, to access the functionality of start-up flow 102. A determination can be made by accessing a database of system 100 (not shown) that can contain user information including, but not limited to, user identification, subscription information, demographic information, user profile, and credit information. If the data in the database indicates that the user does not have credits, start-up module 102 provides access control mechanism 206 to the user, which provides the user the ability to select a subscription, pay for the subscription, process their payment, and store the user information indicating that they are a registered user in the database of system 100. In embodiments, subscription options can include, but are not limited to, monthly and/or annual subscriptions.

If the user does have credits and/or is otherwise registered, get started mechanism 202 is presented to the user. The user can select an ideation style, more fully described below, corresponding to a content type that the user wishes to create. In the examples herein, three different ideation styles are described further below, which include, but are not limited to, a rant style, a perspective style, and an educational content style. Once an ideation style is selected by the user, System 100 provides a profiling mechanism 204 to the user. Profiling mechanism 204 provides an adaptive and simple profiling questionnaire to the user to promote an ideation process. In embodiments, the adaptive profiling questionnaire can be arranged to correspond to the available ideation styles (in this example, rant style, perspective style, and educational content style).

Returning to the Figures, profiling mechanism 204 can interface, through Application Programming interfaces (APIs), with generative Artificial Intelligence (AI), i.e., ChatGPT or the like. Start-up module 102 completes its process when a profile created by profiling mechanism 204 is stored to the database of System 100.

A content creation module 104 enables the user to, optionally, search, view, and/or select engagement content to be used in the background of the screen where the question is presented to the user during the videotaping of the answers. Certain colors support cognitive function and stimulate the user when answering questions in a manner that encourages the user to share their perspective. After this optional step of selection of engagement background, content creation begins with the generation, in real time, of a desired number of questions from the database of System 100. Each question is unique to the user and is developed based on the profile that they set up during signing up to become a user. The profile can identify, for example, niches or industries the user is involved with, their mentoring experiences, who their competitors are, and who inspires them. The questions are developed by AI, in real time, based on specific criteria that target their ideal audience when the user indicates they want to “Create New Project”. The profile information input can narrow down the audience that will be targeted, for example men over the age of 40 and/or entrepreneurs and/or women over the age of 35 and/or online coaches. These criteria can be selected from an existing list, and new criteria not already existing in the available criteria can be entered on the fly. Once the audience is targeted by completion of the audience criteria the user can fill in perspective information, which is simply a short written explanation of the perspective that will be used to generate the content for the project. Finally, based on the criteria and perspective input, questions are generated, via AI tools, which are unique to the profile information input by the user.

The content is curated by the user as a series of recorded responses to the questions that are retrieved. In embodiments, an AI system can provide a human-like voice prompt to ask the user the questions, in an interview style. Each question-answer pair is video-recorded as a separate content item, which can then be stored in the database of System 100. Once stored, each video can be operated on by AI standard or custom video editing tools to produce curated content. In embodiments, an AI tool can be provided to record, edit, and/or otherwise curate stored video content. For example, the provided AI tool can edit recorded content into, for example, long form video curated content (e.g., more than 5 minutes long) or short form video curated content (under 3 minutes). Still further, the provided AI tool can process the curated content, through APIs, to create the social media formats with captions specific to each social media platforms specifications, i.e., additional data and metadata associated with the curated content including, but not limited to, transcriptions, still images, quotes, memes, GIFs, etc. Content creation module 104 tasks are completed when all curating, editing, and addition of data is finished, and the final content is stored in the database of System 100.

A content finalization module 106 provides the finalized curated content to the user via a dashboard 230. In embodiments, the dashboard 230 provides the user a view of all curated content that has been produced, edited, and finalized by the video-editing AI tool. For example, the dashboard 230 can include finalized created content including, but not limited to, video content, social media content generated from the video content, email copies generated based on the video content, and/or stills/quotes/GIFs/Memes generated based on the video content. The user can perform a number of functions with content finalization module 106 including, but not limited to, downloading finalized created content or deleting finalized created content.

Content scheduling module 108 can begin its process when the user provides an initial schedule for publishing finalized created content, or alternatively a user can utilize an AI tool to determine the most effective schedule for publishing content. Once content is scheduled for publishing, an AI tool interfaces with publishing targets, in a known manner, through APIs, to provide published content to the publishing targets. In embodiments, publishing targets can include, but are not limited to, social media platforms, e-mail communications, and/or websites. Furthermore, AI tools can provide, in a known manner, the necessary APIs to directly interface with publishing targets. Content scheduling module 108 completes its process when the user approves the content and schedule for publication.

This process enables each user to create and maintain brand standards in their unique style or voice. The present invention captures the actual essence of the user, versus using the standard approach of allowing current AI processes to develop a message based on what is virtually available online, which is more robotic-like and loses the brand authenticity. For example, a rant style might present questions designed to produce longer and more conversational answers that can then be used to create less wooden, more conversational or attention-grabbing content. A first question of a sequence of questions might be: “What behavioral patterns stand out most when meeting clients virtually versus in-person?”

A transcript of a video of the user answering this question might read:
“You can test and see their whole body language. Generally, virtual meetings are from the mid-chest up, which is more telling to me than anything else. And what I mean by that is, you can see their eyes, you can see their eye behavior, you can see and hear their speech pattern, their tone, whether they're paying attention or whether they just agreeing without really processing what is being said. A big clue of this is when they are answering ‘oh yeah, yeah, yeah, for sure, yeah.’ When they simply say ‘yeah’ repeatedly, that typically means that they're really not listening and so what you can do with most of these types of responses in virtual meetings, where you're able to have a real back-and-forth with them, is to say something like ‘I can wait till you're done.’ And while saying this may come off as rude, it can kind of ‘shock’ them and they will notice that you're actually paying attention to them.”

Using this transcript, AI is then used to develop social media copy, tailored to a format used with each desired social media platform. As an example, the following content asset could be created for use with video on the Facebook platform:
“Let's talk about reading the room in virtual meetings . . . . Even through a screen, body language speaks volumes! From eye movements to speech patterns, every gesture tells a story. When someone's giving you the repetitive “yeah, yeah”-they're checked out. Here's your power move: Pause. Say “I can wait until you're ready.” Watch how quickly they snap back to attention!”

By way of contrast, here is an example of how the same transcript can be used to create copy for the TikTok platform:
“POV: When they keep saying “yeah yeah” in your virtual meeting [symbol] Watch till the end for the perfect comeback! #BusinessTok #SalesHacks

Another example of a question for a rant-style ideation could be: “What specific moments help you find clarity between overthinking versus being overstimulated in your business decisions?”

A transcript of a video of the user answering this question might read:
“Moments that I really hope I can apply to a sale, right? So when I'm overstimulated with too much information, I kind of get bogged down. So when I'm giving a potential client, um, you know, the solutions explaining where we're at and what we're working through, I really want to see, um, I really have to stop for a second and kind of go, it's too much information for them. It's too much information for me, and when I'm receiving this much, I need to cut it down. The overthinking part is simple. The overthinking portion is like, what is really in my way? You know, um, when do I want to make this decision? So I, I first start by really looking at what decision and where it's holding me stuck and when I can do that, it's a game changer.”

Using this transcript, according to the present invention, AI is used to develop the social media copy. As an example, the following content asset could be created for use with video on the Facebook platform:
“Let's talk about the elephant in the room: Information overload is killing your sales performance. I've been there. Drowning in data, stuck in analysis paralysis, watching opportunities slip away. Here's your power move: Identify the ONE decision holding you back. That's it. That's your game-changer.”

By way of contrast, here is an example of how the same transcript can be used to create copy for the X platform:
“Stop drowning in data! The secret to closing deals? Keep it simple [symbol] When information overload hits, pause. Focus on the ONE decision holding you back. That's your breakthrough moment [symbol] ”

Other ideation styles operate in a similar way, but with questions tailored to develop different kinds of answers that in turn will enable AI to generate different styles of copy. Sticking with the examples described herein, the perspective style might present questions that enable the user to “activate their genius with the reasoning behind the expertise”, i.e., that will elicit answers that have the user demonstrate and explain their experience in a particular field. An example question might be “What sparked your realization that chasing stocks wasn't the best investment strategy?” The educational content style might present questions enabling the user to demonstrate their expertise in a particular subject. An example question for this ideation could be: “What remarkable changes would you expect to see in your garden if everyone embraced drought-resistant flowering plants?” As with the examples given above with respect to the rant ideation, transcripts of the user's answers to these questions, extracted from their video-captured answers to the questions, are used with AI to create social media content tailored to the format of the particular social media platform it is being delivered by. As noted above, the process of the present invention enables each user to maintain brand standards in their unique style or voice, and it captures the actual essence of the user, versus using the standard approach of allowing current AI processes to develop a message based on what is virtually available online, which is more robotic-like and loses the brand authenticity.

The inventive systems and methods provide numerous advantages, some of which are illustrated below. By combining multiple applications, and/or AI tools the system 100 allows the user to streamline the marketing process. The interactive AI tools can prompt the user to ideate and market themselves to their ideal client base using questions tailored to the message and “voice” of the user. The simplified interface can support the user to feel the ease of producing marketing content with confidence. The system 100 can streamline and connects multiple AI tools, while supporting the user through AI prompts to help them produce marketing materials that better target their ideal clients organically. Finally, AI-based editing, production, and scheduling remove resource burdens from the content creation process for the user.

A general example of the use of a novel process of the claimed invention follows, illustrating how the claimed invention enables the creation and use of ideation styles to develop content having different formats. For example, the user chooses his or her specific audience or audiences (e.g., online coaches), and a specified feeling that the user wants to convey to the audience. The user may input to the system their wish to convey their perspective with an aggressive feeling, and empathetic emotion, sharing a devastating story or memory of loss. It could be a progression of funny, sarcastic tones, or an emotional essence of the user in the moment that allows the potential audience to connect and grasp the overall message written or on video using Amazon Rekognition for the persona using Amazon Web Services (AWS) to transcribe the written copy. The type of ideation style chosen will impact, for example, what questions are used, how the questions are phrased, and how many questions there will be. The user shares his or her perspectives, expertise, and emotions while answering each individual question. Using the questions and answers, the AI processes of the present invention develop a first edited video and write the social media copy to be posted with the corresponding video, focused on the tone that is appropriate for a first social media platform as input by the user, and can, using the same questions and answers, create second, third, fourth, etc. versions of video and copy that are focused on the different formats appropriate for the second, third, fourth, etc. social media platforms. It will also produce an impactful quote per question, and an email sequence that will link directly to an email service provider for email campaigns.

As noted above, the user can choose from different styles of questions to create different ideation styles of content. In the examples discussed herein, the ideation type “RANT” develops three direct to-the-point questions; “PERSPECTIVE” triggers a five-question sequence showcasing a user's expertise; and “EDUCATIONAL” initiates a fifteen-question sequence that develops a value proposition based on experiences. The styles and number of questions described herein are for purpose of example only, and it is understood the invention contemplates that any type of style and any number of questions can be utilized and will still fall within the scope of the claimed invention.

Essentially, in the development of the ideation style, the user decides on the audience(s) to be targeted, and the perspective that the user wants to share with the audiences(s). The style of questions to be used (e.g., “rant”, “perspective”, and “educational”) is chosen, and then questions are then developed, via API using the prompt architecture discussed herein to produce each style of specific line of questioning depending on the target audience and target perspective as well as taking into account the users initial profile set up, that conform to the chosen style. The user is then video-recorded answering the questions. The choosing of the they style of questions can be referred to as an “Adaptive Profile”, which is choosing a style of questions the user would use to express their subject matter expertise.

In an embodiment, “Rant” comprises, e.g., three questions of a style that cues the user to answer in a short, direct manner with more of a contrasting style question, e.g., a short direct line of questions which will elicit answers that provide contrasting viewpoints illustrating differences between, e.g., a product/service and a competitor's product/service. The following is an example of a “Rant” style project:

Project Name: “Wealth Management”

Questions for this project:
a. ⅓ “What inspired your shift toward focusing on financial independence rather than traditional 401k investments?”
b. ⅔ “How did your life experiences shape your current perspective on building wealth outside retirement accounts?”
c. 3/3 “What feelings emerge when you think about the freedom your financial strategy provides compared to relying solely on a 401k?”

“Perspective” uses an experiential approach using, e.g., five questions of a style that cue the user to express themselves by sharing experiences in their answers. The following is an example of a “Perspective” ideation style project:

Project Name: “System VS Intuition”

Questions for this project:
a. ⅕ “What specific clarity have you gained from using precise actions versus intuitive conversations in your client's journey?”
b. ⅖ “How does it feel when your structured sales process fails to support a potential client's needs?”
c. ⅗ “What personal experience convinced you that precise actions create better results in your sales process?”
d. ⅘ “What transformations in client clarity could occur if you fully committed to a structured sales approach?”
e. 5/5 “Do you oppose the idea that structured support systems might limit authentic client connections?”, e.g.,”

The Educational ideation style uses a much longer series of questions, e.g., fifteen questions, that takes the user on a “journey” that elicits answers that share the what, how, and when of what the user has experienced over time, to demonstrate the fact that they are a subject matter expert, allowing a “story” to be developed form the answers and thereby hook the audience to follow the story.

Another novel aspect of the claimed invention is the use of what the Applicant has termed “AI persona video analysis.” AI persona video analysis captures the emotional state of the user in real time to breakdown how to develop the copy. This develops an emotional hook with the potential audience as the manner in which the user answers the question can convey their passion for the subject, their emotional connection to the subject, which can be interpreted by the audience as indicating that the person is an expert on the subject. AI tools can sense/analyze the intensity (or lack of intensity, or other emotional cues) of the user in the recorded video to decide how to edit the video, focusing on answers or portions of answers that convey the emotional cues. This will form nor only how the video is edited, but it also supports writing the copy in an emotional context. This can be important to enable the message, whether it is in written form or video form, to be aligned for the target audience.

A further novel aspect of the claimed invention is the creation of what the Applicant calls “social media copy.” The claimed invention provides a platform that creates content specific to a social media platform demographic. In this process, one or more delivery platforms are chosen (e.g. social media platforms like Facebook, Instagram, TikTok, X, LinkedIn, Pinterest, etc.) and then copy is separately tailored to the demographic and style of each selected delivery platform, using AI, to create delivery-platform-specific content that conveys the perspective (ideation style) the user chose to the target audience(s). It will be different for each platform in most cases, with nuanced differences dictated by the style and demographic of the delivery platform. Several different parameters can be used to develop traction on a specific social media platform. Facebook, Instagram, TikTok, and X content is created directed to their primary generational demographic. Pinterest content is created with a gender specific language pattern because statistically is has been shown that more women than men utilize the Pinterest platform. LinkedIn content in created using a professional tone because LinkedIn is used primarily by professionals for professional networking. Because YouTube is used to present a great deal of educational content, the claimed invention creates content for YouTube that has an educational tone.

For each question, the user will record a video answer. Each answer is then processed on the server to capture the transcription. Using the transcription, the analyzed persona, and the viewpoint entered when project was created, AI will generate unique assets for social media, which includes a properly edited and resized video for each social media platform, and copy to be posted that resonates with the user behavior of each social media platform. AI will also generate graphic quotes, based on the same, and will also generate an email copy asset, which consists of subject and body.

The present invention also provides a novel and valuable tool for developing lead magnets. As is well known, in marketing a lead magnet is a free resource or incentive offered to potential customers in exchange for their contact information-usually an email address. Its purpose is to attract and convert prospects into leads by providing immediate value. A novel aspect of the present invention it can be used to develop lead magnets by virtue of the transcripts created during implementation and use. Lead magnets will be developed based on the transcripts from the “Adaptive Profile” answers, making each content element produced unique to the user, unlike other marketing AI platforms available. Once the present platform has enough stored data based on transcripts, AI tools are applied to distinguish key words or key phrases. It then develops those assets (lead magnets) based on that stored data. The user will be alerted to the option to develop certain aspects during this process using our platform. Marketing assets include any sort of digital campaign (lead magnet/asset), like: Blog Posts, eBooks, Quiz Funnels, Mini Course, or Challenges.

The following is an example “walk-through” illustrating the operation and use of the method and processes of the present invention, using an exemplary dashboard displayed in a graphic user interface. It is understood that the order of the described steps and the manner in which the dashboard gathers and processes the input can be varied, e.g., for stylistic reasons, and will still fall within the scope of the claimed invention.

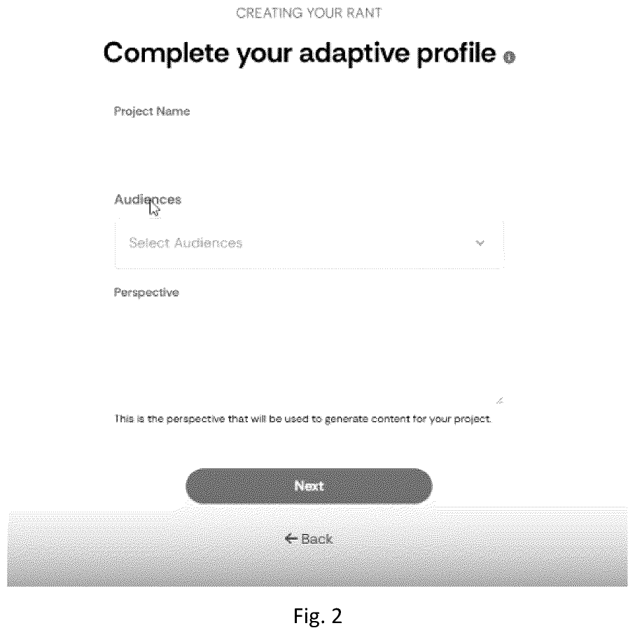

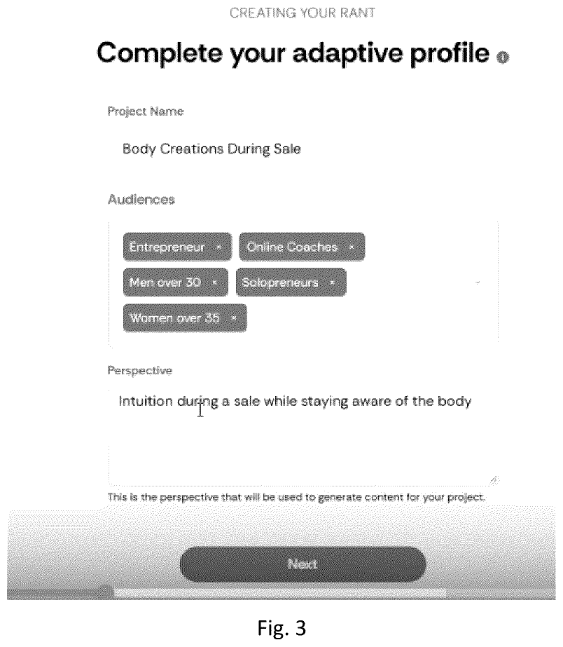

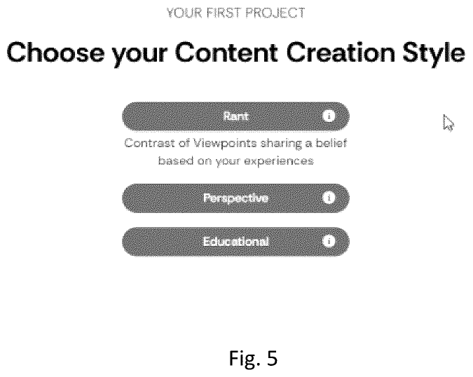

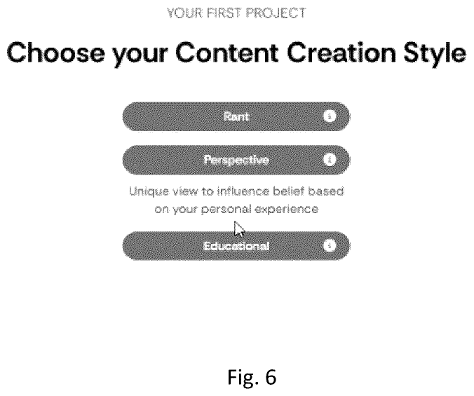

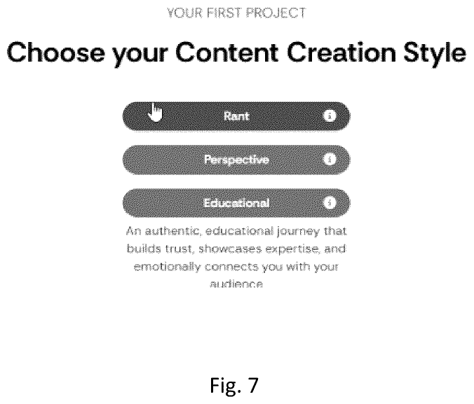

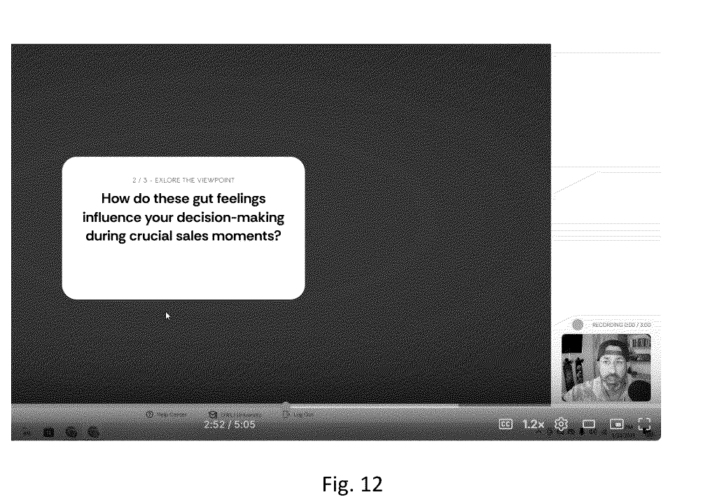

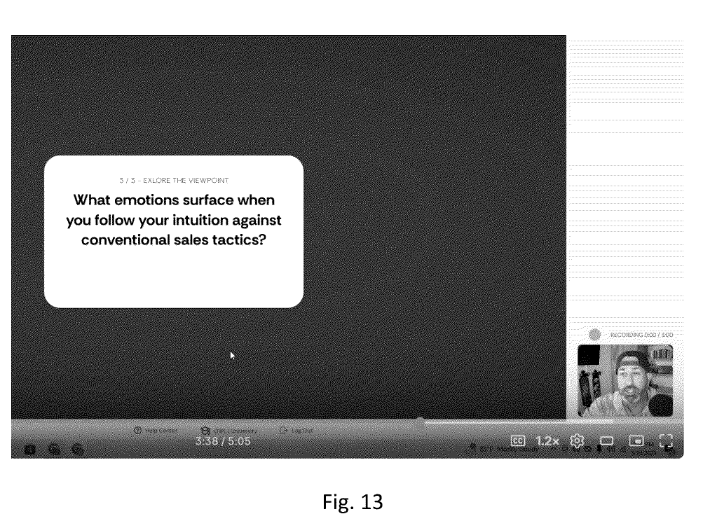

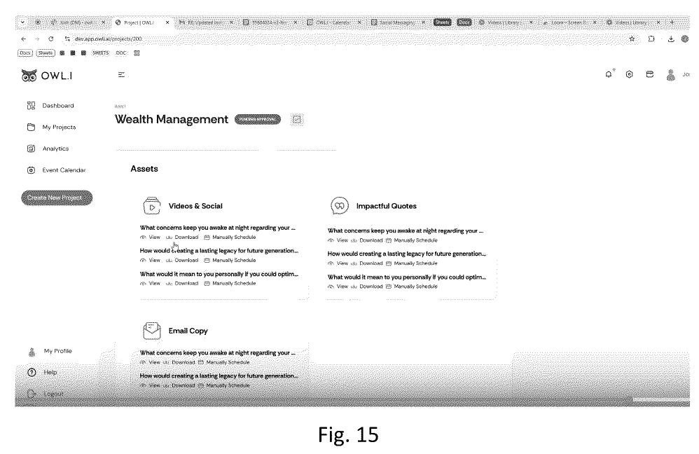

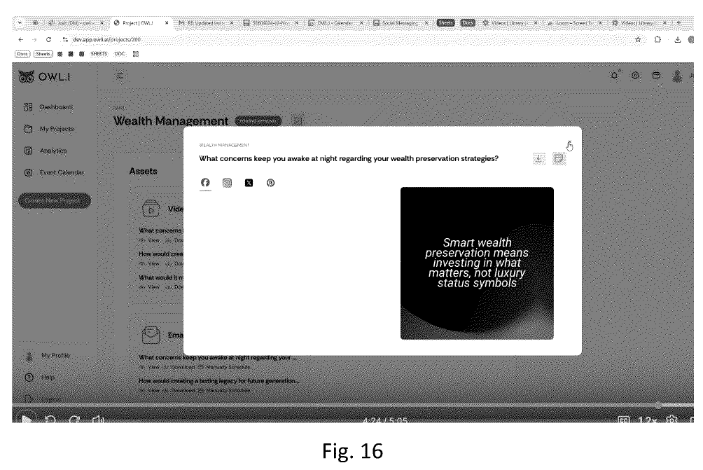

Referring to FIGS. 2-16, a user profile is developed by the user filling out an adaptive profile during an initial set up (FIGS. 2-3). This could include information such as a project name, business name, industry, company size and the like. This could also include a target audience, selectable from a dropdown menu of previously-configured audiences and/or manually input on the fly in the case where a preconfigured selection for a desired audience is not available on the dropdown menu. As an example, the user could choose a project name; in this example the user names the project “Body Creations During Sale” because the purpose of the project is to teach about the importance of exhibiting proper body language during the process of conducting a sale. Next the user identifies the target audience, e.g., Entrepreneurs, Online Coaches, Men Over 30, Solopreneurs, and Women Over 35. Next, the user inputs a perspective to be conveyed; in this example the user inputs “Intuition during a sale while staying aware of the body” and then presses the “next” button to proceed.

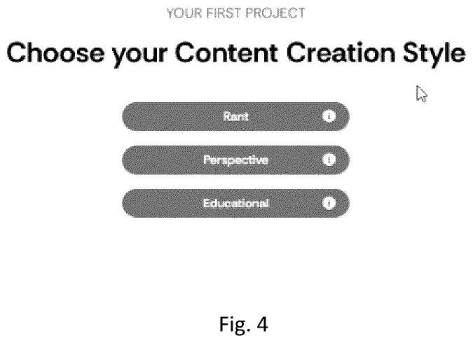

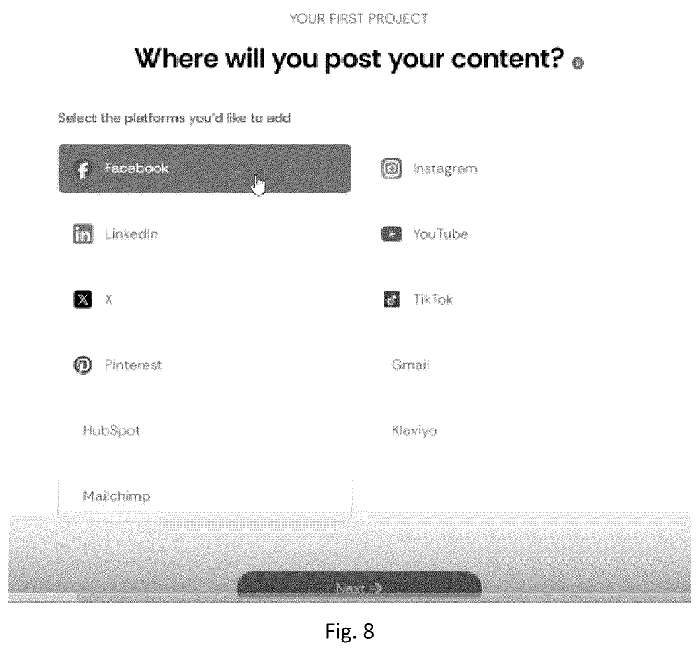

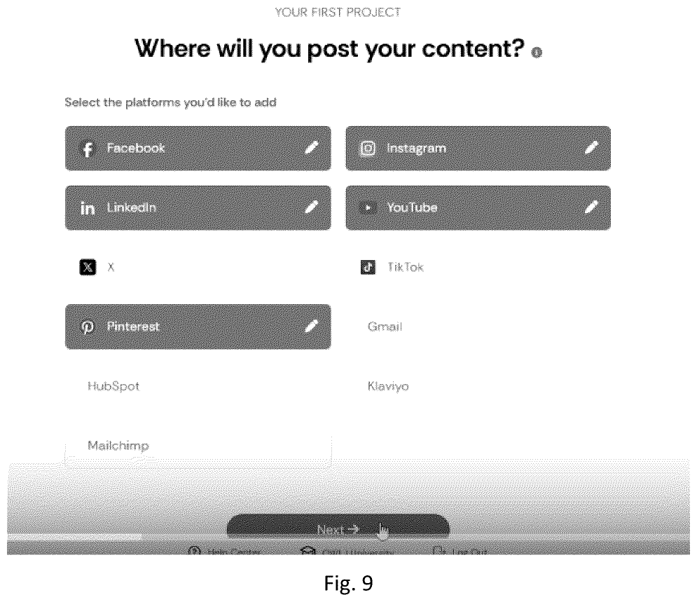

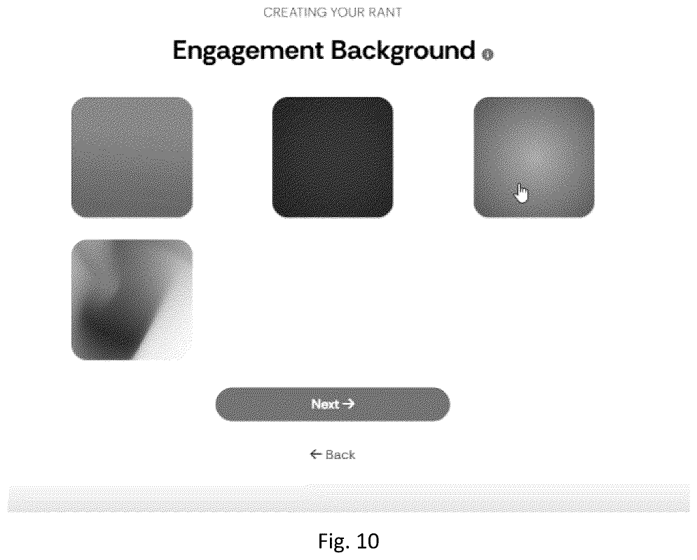

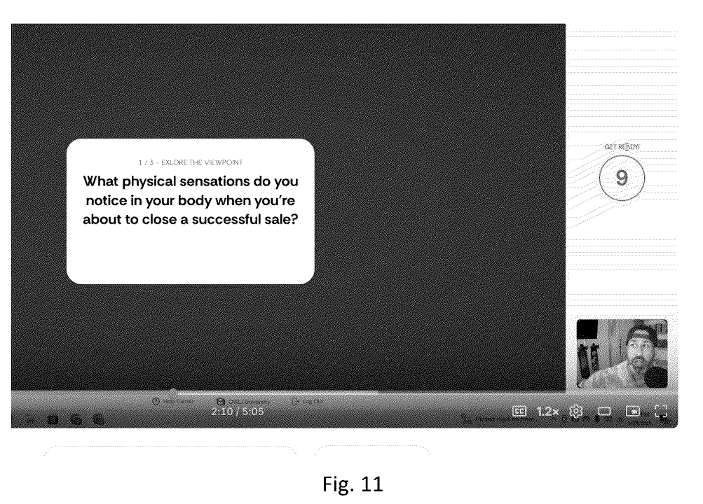

Next, an ideation style can be selected (FIGS. 4-7). In this example the choices are “Rant”, “Perspective”, or “Educational”. The user in this example chooses “Rant” presses the “next” button to proceed, and then chooses the platforms to which the assets will be posted (FIGS. 8-9). In this example, the user selects Facebook, Instagram, LinkedIn, YouTube, and Pinterest and presses the “next” button to proceed. The user then selects a background to be displayed in the background of the questions to be presented to the user when recording the video answers (FIG. 10) and then tests the camera and mic before recording, and then presses the “next” button to proceed. This will trigger the first question to be displayed on the screen (FIG. 11), and recording will automatically begin after a delay, e.g., 10 seconds to allow the user time to process the question before answering. The user can hit “next” when they are finished with the answer. In a preferred embodiment there is a maximum recording time of 3 minutes for answering each question. This process will be repeated for all the remaining two questions (FIGS. 11-13).

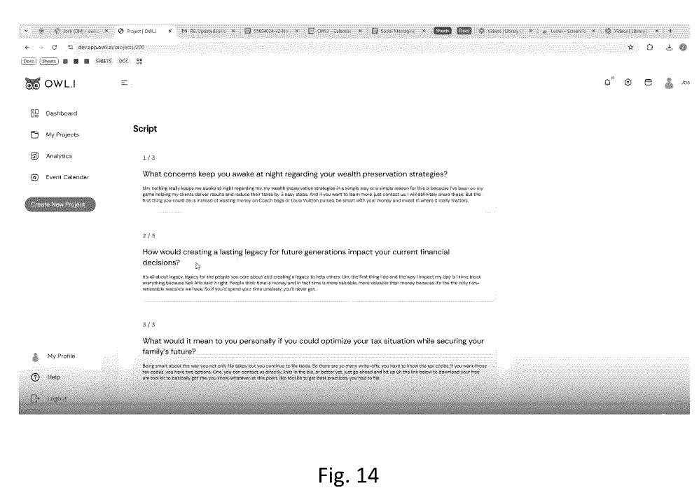

Once finished with all three questions, the process proceeds to process the transcripts of the answers, and each individual asset is developed: edited/produced video with corresponding unique social media copy, a most impactful quote, and an email sequence, per question (FIGS. 14-16 are examples showing these processes having been completed for content directed to “Wealth Management”). In this example with three questions, there will be three videos produced with social media copy and hashtags, three impactful quotes created, and three emails generated. The assets will be created and stored, for example, under a “MY PROJECTS” section on the platform and they will be viewable for approval to be posted. Once an asset is approved for posting, they will be scheduled for posting. Email assets will be sent to EPS/CRM (email provider service) that the user has integrated on the platform.

In an embodiment, the invention comprises a computer-implemented method for developing AI-assisted content, comprising: an adaptive profile input form configured to receive profile information for a content asset via an input mechanism;
an ideation style input form configured to receive an ideation style selection via said input mechanism;
a platform selection form configured to receive one or more platform selections via said input mechanism;
a recording mechanism configured to enable the video and audio recording of audio/video content;
an AI-assisted question generator configured to generate one or more questions based on the profile information and selected ideation style, and display the one or more questions to a user; and
an AI-assisted content generator configured to analyze audio/video content and generate content platform-specific content for each platform selection; whereby:
the user is recorded by the recording mechanism answering each displayed question;
the AI-assisted content generator analyzes the user's recorded answers to each question and edits the audio/video content based on the profile information and the one or more platform selections and prepares the content for delivery via said one or more platform selections.

In another embodiment, the invention comprises a system for developing AI-assisted content, comprising: an adaptive profile input form configured to receive profile information for a content asset via an input mechanism;
an ideation style input form configured to receive an ideation style selection via said input mechanism;
a platform selection form configured to receive one or more platform selections via said input mechanism;
audio/video recording means for recording audio/video content;
an AI-assisted question generator configured to generate one or more questions based on the profile information and selected ideation style, and display the one or more questions to a user; and
an AI-assisted content generator configured to analyze audio/video content and generate content platform-specific content for each platform selection;
   whereby:
the user is recorded by the recording mechanism answering each displayed question; and
the AI-assisted content generator analyzes the user's recorded answers to each question and edits the audio/video content based on the profile information and the one or more platform selections and prepares the content for delivery via said one or more platform selections.

In another embodiment, the invention comprises a computer program product for developing AI-assisted content, the computer program product comprising a computer-readable storage medium having computer-readable program code embodied in the medium, the computer-readable program code comprising:
computer-readable program code that generates an adaptive profile input form configured to receive profile information for a content asset via an input mechanism;
computer-readable program code that generates an ideation style input form configured to receive an ideation style selection via said input mechanism;
computer-readable program code that generates a platform selection form configured to receive one or more platform selections via said input mechanism;
computer-readable program code that instructs a recording mechanism configured to enable the video and audio recording of audio/video content;
computer-readable program code that instructs an AI-assisted question generator configured to generate one or more questions based on the profile information and selected ideation style, and display the one or more questions to a user; and
computer-readable program code that instructs an AI-assisted content generator configured to analyze audio/video content and generate content platform-specific content for each platform selection;
   whereby:
the user is recorded by the recording mechanism answering each displayed question; and
the AI-assisted content generator analyzes the user's recorded answers to each question and edits the audio/video content based on the profile information and the one or more platform selections and prepares the content for delivery via said one or more platform selections.

The above-described steps and processes can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

Program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A computer-implemented method for developing AI-assisted content, comprising:
an adaptive profile input form configured to receive profile information for a content asset via an input mechanism;
an ideation style input form configured to receive an ideation style selection via said input mechanism;
a platform selection form configured to receive one or more platform selections via said input mechanism;
a recording mechanism configured to enable the video and audio recording of audio/video content;
an AI-assisted question generator configured to generate one or more questions based on the profile information and selected ideation style, and display the one or more questions to a user; and
an AI-assisted content generator configured to analyze audio/video content and generate content platform-specific content for each platform selection;
whereby:
the user is recorded by the recording mechanism answering each displayed question; and
the AI-assisted content generator analyzes the user's recorded answers to each question and edits the audio/video content based on the profile information and the one or more platform selections and prepares the content for delivery via said one or more platform selections.

2. The computer-implemented method for developing AI-assisted content according to claim 1, wherein the content comprises social media content.

3. The computer-implemented method for developing AI-assisted content according to claim 2, wherein the audio/video content is transcribed and stored for analysis by the AI-assisted content generator.

4. The computer-implemented method for developing AI-assisted content according to claim 3, wherein the content prepared by the AI-assisted content generator includes one or more impactful quotes selected by the AI-assisted content generator from the transcribed audio/video content.

5. The computer-implemented method for developing AI-assisted content according to claim 4, wherein the one or more questions displayed to the user are displayed on a user-selected background.

6. A system for developing AI-assisted content, comprising:
an adaptive profile input form configured to receive profile information for a content asset via an input mechanism;
an ideation style input form configured to receive an ideation style selection via said input mechanism;
a platform selection form configured to receive one or more platform selections via said input mechanism;
audio/video recording means for recording audio/video content;
an AI-assisted question generator configured to generate one or more questions based on the profile information and selected ideation style, and display the one or more questions to a user; and
an AI-assisted content generator configured to analyze audio/video content and generate content platform-specific content for each platform selection;
whereby:
the user is recorded by the recording mechanism answering each displayed question; and
the AI-assisted content generator analyzes the user's recorded answers to each question and edits the audio/video content based on the profile information and the one or more platform selections and prepares the content for delivery via said one or more platform selections.

7. A computer program product for developing AI-assisted content, the computer program product comprising a computer-readable storage medium having computer-readable program code embodied in the medium, the computer-readable program code comprising:
computer-readable program code that generates an adaptive profile input form configured to receive profile information for a content asset via an input mechanism;
computer-readable program code that generates an ideation style input form configured to receive an ideation style selection via said input mechanism;
computer-readable program code that generates a platform selection form configured to receive one or more platform selections via said input mechanism;
computer-readable program code that instructs a recording mechanism configured to enable the video and audio recording of audio/video content;
computer-readable program code that instructs an AI-assisted question generator configured to generate one or more questions based on the profile information and selected ideation style, and display the one or more questions to a user; and
computer-readable program code that instructs an AI-assisted content generator configured to analyze audio/video content and generate content platform-specific content for each platform selection;
whereby:
the user is recorded by the recording mechanism answering each displayed question; and
the AI-assisted content generator analyzes the user's recorded answers to each question and edits the audio/video content based on the profile information and the one or more platform selections and prepares the content for delivery via said one or more platform selections.
